(19) United States
(12) Patent Application Publication
(10) Pub. No.: US 2015/0091496 A1
(43) Pub. Date: Apr. 2, 2015

(54) BI-DIRECTIONAL COMMUNICATION WITH A DEVICE UNDER CHARGE

(71) Applicant: BLACKBERRY LIMITED, Waterloo (CA)

(72) Inventors: Marc Élis Meunier, Kitchener (CA); Vahid Moosavi, Kitchener (CA); Scott Douglas Rose, Waterloo (CA); Lyall Kenneth Winger, Waterloo (CA); Ahmed Abdelsamie, Nepean (CA)

(73) Assignee: BLACKBERRY LIMITED, Waterloo (CA)

(21) Appl. No.: 14/042,914

(22) Filed: Oct. 1, 2013

(51) Int. Cl. H02J 7/02

(52) U.S. Cl. CPC H02J 7/025
USPC 320/106; 320/137; 320/108

(57) ABSTRACT

A first device is wirelessly charged by a second device. Bi-directional communication is performed between the first device and the second device during the wireless charging, where the bi-directional communication includes messaging from the second device to the first device, the messaging including information other than information relating to wireless charging.

### BACKGROUND

Wireless power allows an electronic device to be provided with power without the use of wires. A power transmitter transfers energy in a wireless manner to a power receiver. Inductive coupling can be used to transfer electromagnetic energy between the power transmitter and the power receiver. The energy that is transmitted to the power receiver can be used by the power receiver to charge a battery of the power receiver, and to provide power to components of the power receiver to allow the components to operate.

### BRIEF DESCRIPTION OF THE DRAWINGS

Some embodiments are described with respect to the following figures.

FIG. 1 is a block diagram of an example arrangement that includes a power charger and a device under charge (DUC), in accordance with some implementations.

FIG. 2 is a schematic diagram of content of a Near-Field Communication (NFC) Data Exchange Format (NDEF) message, according to some examples.

FIG. 3 is a block diagram of further components in a power charger and a DUC, according to further implementations.

FIG. 4 is a flow diagram of a process relating to bi-directional communication between a power charger and a DUC, according to some implementations.

FIGS. 5 and 6 are block diagrams of further example arrangements including a power charger and a DUC, according to further implementations.

### DETAILED DESCRIPTION

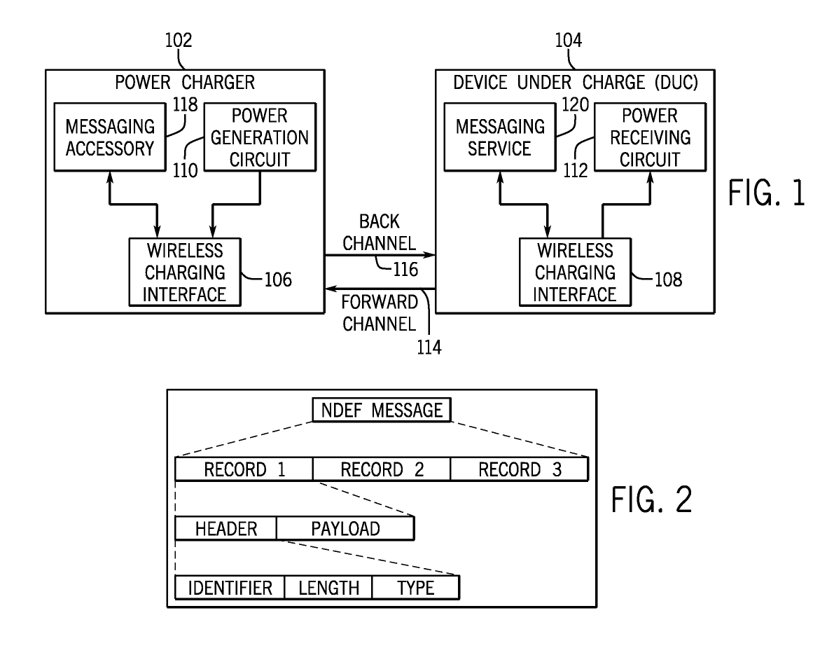

FIG. 1 is a block diagram of an example arrangement that includes a power charger 102 (also referred to as a power transmitter) and a device under charge (DUC) 104 (also referred to as a power receiver). Examples of DUCs can include any or some combination of the following: a smartphone, a portable digital assistant, a tablet computer, a notebook computer, a game appliance, or any other portable device or other type of electronic device that can be wirelessly charged.

The power charger 102 can be any device that includes or is coupled to a power source, such as an AC wall outlet, a battery, and so forth. The power charger 102 can be a charging station or a docking station. In some examples, the power charger 102 can include a flat upper surface on which one or more DUCs can be placed for wireless charging. In other examples, the power charger 102 is able to wirelessly charge one or more DUCs within a specified distance of the power charger 102.

A power charger wirelessly charging a DUC refers to the power charger producing electrical energy (e.g. electromagnetic energy) that can be received by the DUC in a wireless manner, where the received electrical energy can be used to charge a battery of the DUC, or power component(s) of the DUC, or both.

The power charger 102 includes a wireless charging interface 106, and the DUC 104 includes a wireless charging interface 108. The wireless charging interfaces 106 and 108 allow the power charger 102 to wirelessly charge the DUC 104. For example, the wireless charging can be accomplished by using inductive coupling, in which electromagnetic energy is transferred from the power charger 102 to the DUC 104.

Inductive coupling is performed between induction coils, including a first induction coil in the wireless charging interface 106 and a second induction coil in the wireless charging interface 108. When the power charger 102 and the DUC 104 are brought into sufficient proximity with each other (to within a specified distance of each other), an electromagnetic field produced by the first induction (in the wireless charging interface 106 of the power charger 102) induces an electrical current in the second induction coil in the wireless charging interface 108 of the DUC 104.

To allow for wireless charging at greater distances between the power charger 102 and the DUC 104, some implementations can employ resonant inductive coupling, in which finely tuned resonant circuits are used in the wireless charging interfaces 106 and 108. Resonant inductive coupling transfers power between two inductive coils that are tuned to the same resonant frequency.

In some implementations, the power charger 102 and the DUC 104 can perform wireless charging according to a wireless charging protocols provided by the Wireless Power Consortium (WPC). An example of a wireless charging protocol is described by the Qi standard from the WPC.

Although reference is made to WPC wireless charging according to some implementations, it is noted that in other implementations, wireless charging of the DUC 104 by the power charger 102 can be according to other techniques.

In addition to the first induction coil, the wireless charging interface 106 of the power charger 102 can further include a wireless charging integrated circuit (IC) device. Similarly, the wireless charging interface 108 can include a wireless charging IC device in addition to the second inductive coil. Each wireless charging IC device can control various operations associated with wireless charging.

The power charger 102 also includes a power generation circuit 110, which produces power that is provided to the wireless charging interface 106 for transfer to the DUC 104. The power generation circuit 110 can produce power from an external power source (e.g. external wall outlet or external battery) or from an internal power source (e.g. internal battery), as examples.

The DUC 104 includes a power receiving circuit 112, which is able to receive power obtained by the wireless charging interface 108 from the power charger 102. The power receiving circuit 112 can include a battery to be charged by the wireless power, and/or circuitry for delivering power to components of the DUC 104.

The WPC Qi standard specifies forward channel communication (over a forward channel 114) from the DUC 104 to the power charger 102. The forward channel communication is over a wireless link established between the wireless charging interfaces 106 and 108. However, the current WPC Qi protocol does not specify communication in the reverse direction, from the power charger 102 to the DUC 104.

The forward channel 114 can be used by the DUC 104 to communicate various messages relating to wireless charging. For example, the DUC 104 can send packets over the forward channel 114 that identify the DUC 104 and that provide configuration and setup information to the power charger 102 for allowing the power charger 102 to wirelessly charge the DUC 104. In addition, the DUC 104 can send control error packets over the forward channel 114 to the power charger 102, where the control error packets are used to increase or decrease the supply of power from the power charger 102 to the DUC 104.

The unidirectional nature of communications between the power charger 102 and the DUC 104 constrains the flexibility of the features that can be provided by the power charger 102 to the DUC 104. In other words, the power charger 102 would be able to provide just wireless charging services to the DUC 104 by using the unidirectional communications provided by the current WPC Qi standard.

In accordance with some implementations, to enhance features that can be provided by the power charger 102 to DUCs, back channel communications can be provided from the power charger 102 to a DUC. As depicted in FIG. 1, a back channel 116 is provided from the power charger 102 to the DUC 104, where the back channel 116 is provided over a wireless link provided by the wireless charging interfaces 106 and 108.

It is noted that the wireless link that provides for the back channel 116 is a wireless link established between the wireless charging interfaces 106 and 108. This avoids having to provide additional communication interfaces in the power charger 102 and the DUC 104 to allow for the establishment of bi-directional communications between the power charger 102 and the DUC 104.

An example of a wireless communication between devices includes near field communication (NFC), which is provided by NFC standards defined by the NFC Forum. To allow for NFC communications, devices can include antennas that create electromagnetic fields when activated. Through magnetic induction, devices can perform NFC communications with each other over short distances, typically less than four centimeters, for example.

However, if NFC communications using traditional NFC interface circuits were to be employed while the power charger 102 is charging the DUC 104, the electromagnetic field created by the wireless charging interface 106 into the power charger 102 may saturate the NFC antennas, and may render such NFC antennas inoperable.

Although reference is made to NFC communications being affected by wireless charging between the power charger 102 and DUC 104, it is noted that other types of wireless communications may also similarly be affected by the wireless charging.

To address the forgoing issue, instead of using separate short-range interface circuits for performing bi-directional communication between the power charger 102 and the DUC 104 when the DUC 104 is brought into close proximity to the power charger 102, the wireless charging interfaces 106 and 108 themselves can be used for the purpose of establishing bi-directional communications over the forward channel 114 and the back channel 116.

As depicted in FIG. 1, a messaging accessory 118 is provided in the power charger 102 to generate messages that are carried over the back channel 116 to the DUC 104. The messaging produced by the messaging accessory 118 includes information other than information relating to wireless charging. Information relating to wireless charging includes information that is used by either or both of the power charger 102 and DUC 104 for purposes of performing control of the wireless charging. Such information can include status information relating to the wireless charging, authentication information authenticating the power charger 102 and/or the DUC 104 for the purpose of authorizing the wireless charging, and any other information related to performing wireless charging.

Examples of messaging that carries information other than information relating to wireless charging includes any one or more of the following: NFC messaging, identification information, status and control information that is other than information relating to wireless charging, and generic messaging for carrying information relating to a sensor or an application in the power charger 102 or an external entity coupled to the power charger 102.

NFC messaging includes an NFC message formatted according to a specific format, such as the NFC Data Exchange Format (NDEF), such as described in the NDEF Technical Specification provided by the NFC Forum. An example of an NDEF message is depicted in FIG. 2. An NDEF message can be used to encapsulate various types and lengths of payload. An NDEF message can contain multiple records that describe unique payloads. Each record includes a header and a payload, where the header indicates the type of message. As further shown in FIG. 2, the header includes an identifier field, a length field, and a type field.

Identification information that can be communicated over the back channel 116 can include a Universal Serial Bus (USB) identifier (ID) that provides an identification of an accessory associated with the power charger 102, a serial number of the power charger 102, an identifier to indicate a class or type of the power charger 102 (such as whether the power charger 102 has a display, a keyboard, a keypad, or other accessory device), or other identification information that is usable by the DUC 104 to determine features available at the power charger 102. For example, the power charger 102 can be considered a “smart” charging or docking station that has features in addition to features relating to wireless charging. The identification information provided over the back channel 114 can allow the DUC 104 to determine what these additional features are.

Note that, in some examples, the DUC 104 can also send identification information (or other information) to the power charger 102 to allow the power charger 102 to identify features of the DUC 104.

More generally, the messaging accessory 118 can provide messaging produced internally in the power charger 102, such as by application software executing in the power charger 102. Alternatively, the messaging accessory 118 can receive messaging from an external entity that is coupled to the power charger 102 over a network (wired or wireless network). For example, the external entity can be a website or any other source of information. The messaging accessory 118 can also allow the DUC 104 to establish a communications session (e.g. web browsing session, call session, chat session, etc.) with the external entity.

In further examples, the power charger 102 can emulate the behavior of an NFC tag. The NFC tag of the power charger 102 can perform one or more of the following functions. For example, the NFC tag and the power charger 102 can enable the establishment of a Bluetooth or a Wi-Fi communications session between the DUC 104 and the power charger 102, using the bi-directional communications provided over the forward channel 114 and the back channel 116.

As another example, the NFC tag can provide the functionality of an NFC smart poster, which is an example of a tag reading function. In this example, the NFC tag stores information that is read by the DUC 104 (over the back channel 116), where the information can include a Uniform Resource Identifier (URI) that the DUC 104 can use for various purposes, such as to open a web page at a remote website, call a number, send an email, send a text message, and so forth. Additionally, the NFC smart poster can include certain information that may be of interest to the user of the DUC 104. For example, such information in the NFC Smart Poster can include a timetable for a bus stop, an airline schedule, and so forth.

Another NFC tag reading function includes provision of a coupon by the power charger 102 to the DUC 104 over the back channel 116, where the coupon can offer a rebate on a good or service that can be purchased by a user of the DUC 104. As another example, an NFC tag reading function can include accessory detection, where the DUC 104 can detect a class or type of an accessory associated with the power charger 102, such that the DUC 104 can set itself up in the corresponding mode to perform communication or interact with the accessory associated with the power charger 102.

NFC tag writing can also be performed. With NFC tag writing, the DUC 104 can provide a message over the forward channel 114 to leave at the NFC tag of the power charger 102. Also, the power charger 102 can provide responsive information pertaining to the tag writing back to the DUC 104 over the back channel 116.

As another example, peer-to-peer communications can be performed between the power charger 102 and the DUC 104 using the forward channel 114 and back channel 116. For example, handshaking associated with setup of a Bluetooth, Wi-Fi, or other communication session can be exchanged in peer-to-peer communications. As a further example, the peer-to-peer communications can be performed for automatic credential setup when the DUC 104 visits a website.

Peer-to-peer communications allows the power charger 102 and DUC 104 to easily share information when they are brought into close proximity with each other. For example, information that can be shared includes photos, videos, music, and other data.

Card emulation can also be performed by the power charger 102. For example, the power charger 102 can include a secure storage device (e.g. a passive tag or other storage device) that can store credit card information or other financial information that can be used to pay for a good or service.

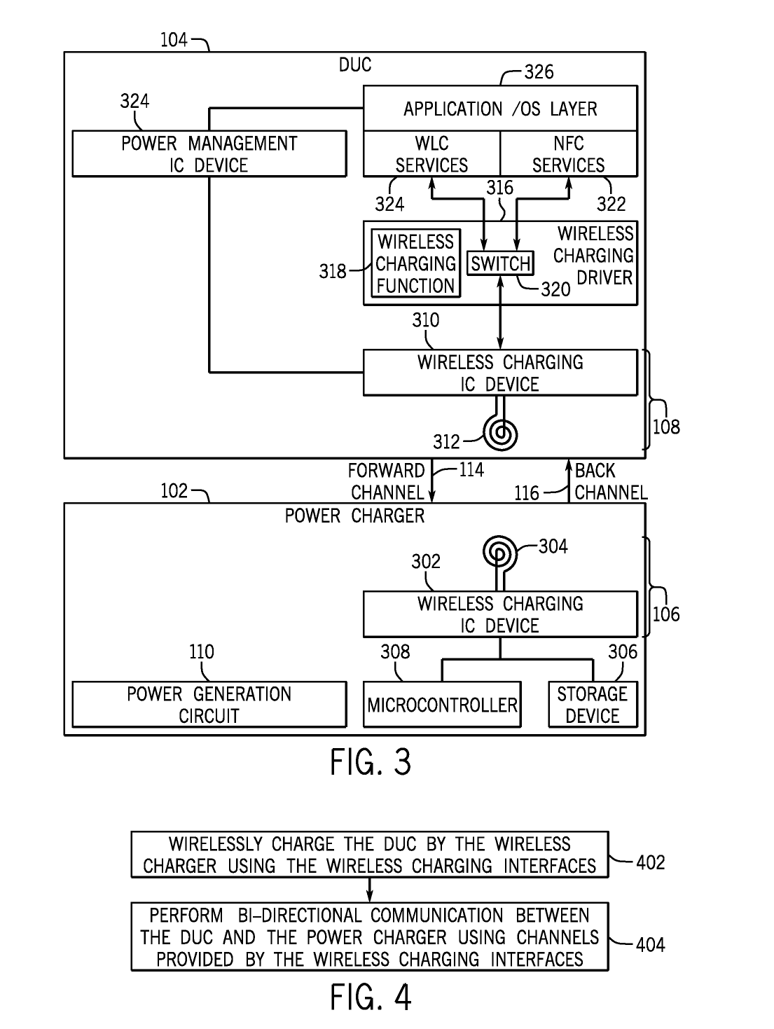

FIG. 3 is a block diagram of illustrating further components of the power charger 102 and DUC 104 according to further implementations. The power charger 102 includes a wireless charging IC device 302 and an induction coil 304, which are part of the wireless charging interface 106 in FIG. 1. In addition, the power charger 102 includes a storage device 306 and a microcontroller 308. The storage device 306 can include a flash memory device, an electrically erasable and programmable read-only memory (EEPROM), or an embedded secure element that is embedded in another device. The storage device 306 can be used to store information that can be provided in messaging communicated over the back channel 116 from the power charger 102 to the DUC 104. In some examples, at least a portion of the storage device 306 is a secure storage element that prevents unauthorized access of data contained in the secure storage element.

The messaging accessory 118 depicted in FIG. 1 can include the microcontroller 308 or the storage device 306, or both. For example, machine-readable instructions (e.g. firmware or software instructions) can be executable by the microcontroller 308 to perform various operations, including producing messages or receiving messages that are to be sent to the DUC 104 over the back channel 116. In alternative examples, instead of the microcontroller 308, a microprocessor or other programmable device can be included in the power charger 308, to provide certain functionalities of the messaging accessory 118.

The DUC 104 includes a wireless charging IC device 310 and an induction coil 312, which can be part of the wireless charging interface 108 of FIG. 1. The DUC 104 also includes a power management IC device 314, which can be part of the power receiving circuit 112 of FIG. 1.

In addition, the DUC 104 includes a wireless charging driver 316, which can be implemented as machine-readable instructions executable on one or more processors (not shown in FIG. 3) of the DUC 104. The wireless charging driver 316 includes a wireless charging function 318, which provides functions associated with wireless charging of the DUC 104 by the power charger 102. For example, the wireless charging function 318 can provide various information (as discussed above) over the forward channel 114 to the power charger 102, which uses this information to control perform wireless charging of the DUC 104.

The wireless charging driver 316 also includes a switch 320, which can direct received messages to one of multiple services modules 322 and 324, in some implementations. The services module 322 is an NFC services module, which is able to send and receive NFC-related messages, such as NDEF messages. NDEF messages received by the switch 320 from the wireless charging IC device 310 are routed by the switch 320 to the NFC services module 322.

In some cases, to reduce the amount of information communicated over the back channel 116, NDEF header information of NDEF messages may be removed such that just the payloads of the NDEF messages are sent over the back channel 116. The receiver (e.g. wireless charging IC device 310 or wireless charging driver 316) in the DUC 104 can re-construct the NDEF header information upon receipt of an NDEF payload, to re-formulate the respective NDEF message. The power charger 102 can provide an indication to the DUC 104 that an NDEF payload has been sent; as a result, the DUC 104 is able to re-formulate the NDEF message upon receipt of the NDEF payload.

Non-NDEF messages received by the switch 320 are routed by the switch 320 to a wireless charging (WLC) services module 324. As examples, non-NDEF messages can include identification information (e.g. USB ID, serial number, etc.) or other type of information that relates to an identification or features of the power charger 102.

In other examples, instead of providing multiple services modules 322 and 324, one of the services module 322 and 324 can be omitted. As further examples, more than two services modules can be included in the DUC 104.

The services modules 322 and 324 can be implemented as machine-readable instructions that are provided between the wireless charger driver 316 and an application and operating system layer 326. In other examples, the services module 322 and/or 324 can be provided in the wireless charging driver 316. The application and operating system layer 326 can include application software and an operating system of the DUC 104.

FIG. 4 is a flow diagram of a process according to some implementations. The process includes wirelessly charging (at 402) the DUC 104 by the power charger 102 using the wireless charging interfaces (108 and 106, respectively) of the DUC 104 and the power charger 102. In addition, the process includes performing (at 404) bi-directional communication between the DUC 104 and the power charger 102 over the forward channel 114 and back channel 116 established between the wireless charging interfaces 108 and 106, while the power charger 102 is wirelessly charging the DUC 104. The bi-directional communication includes messaging from the power charger 102 to the DUC 104 over the back channel 116, where the messaging includes information other than (and in addition to) information relating to wireless charging.

In some examples, an I2C relay can be used to perform communications between the power charger 102 and the DUC 104. I2C communication is performed over an I2C bus between an I2C master and an I2C slave. I2C communication can be according to the I2C bus specification. An I2C relay is a bridge that allows one I2C device on a first I2C bus to access another I2C device located on a different I2C bus; the I2C relay does not have to interpret the data carried between the I2C devices.

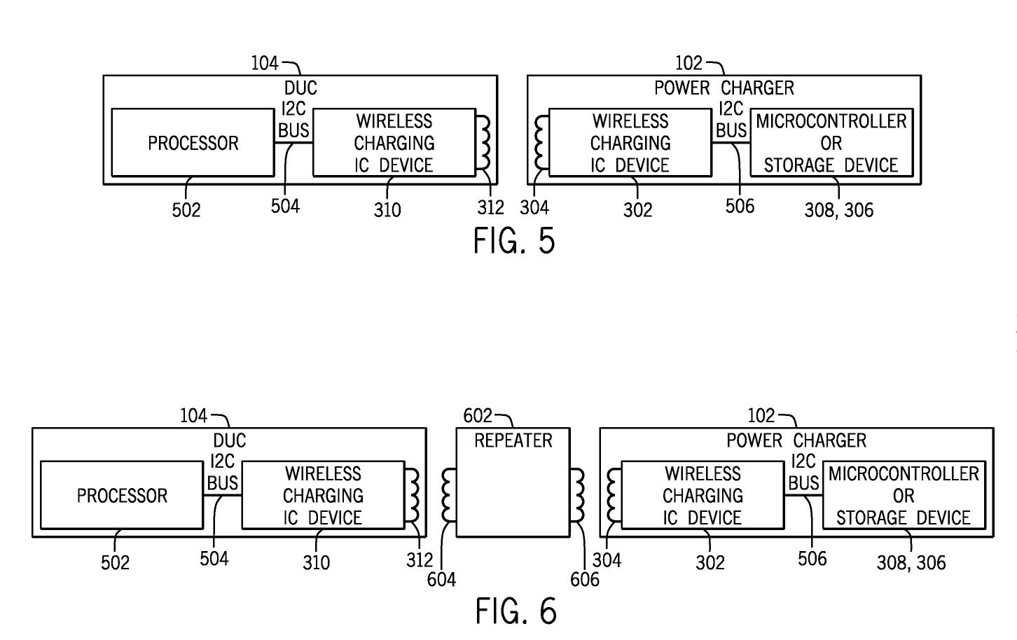

As shown in FIG. 5, the DUC 104 includes a processor 502 and the wireless charging IC device 310. The processor 502 can be the processor on which various machine-readable instructions of the DUC 104, including the wireless charging driver 316, services modules 322 and 324, and the application and OS layer 326, are executable. A processor can include a microprocessor, microcontroller, processor module or subsystem, programmable integrated circuit, programmable gate array, or another control or computing device.

The processor 502 behaves as an I2C master on an I2C bus 504, while the wireless charging IC device 310 behaves as an I2C slave on the I2C bus 504.

In the power charger 102, the wireless charging IC device 302 is an I2C master on an I2C bus 506, while the microcontroller 308 or storage device 306 is an I2C slave on the I2C bus 506.

In communications from the DUC 104 to the power charger 102 over the forward channel 114, the wireless charging IC device 310 behaves as an I2C slave that transmits an I2C message to the wireless charging IC device 302 (which behaves as an I2C master). The transmission of this I2C message leverages a physical communication layer already provided by the wireless charging interfaces of the DUC 104 and power charger 102. The I2C message is then relayed by the wireless charging IC device 302 to the storage device 306 or microcontroller 308 over the I2C bus 506.

In the reverse direction, from the power charger 102 to the DUC 104 over the back channel 116, the storage device 306 or microcontroller 308 sends an I2C message over the I2C bus 506 to the wireless charging IC device 302. In turn, the wireless charging IC device 302 send the I2C message to the wireless charging IC device 310, which in turn sends the I2C message to the processor 502.

In this arrangement, the wireless charging IC devices 302 and 310 together provide an I2C relay. The I2C relay provides a virtual I2C bus that connects the processor 502 in the DUC 104 with the storage device 306 or microcontroller 308 in the power charger 102.

FIG. 6 illustrates an example of an alternative arrangement in which a wireless charging repeater 602 is provided between the power charger 102 and DUC 104. The repeater 602 is able to forward data between the power charger 102 and DUC 104 without interpreting the content of the data. As shown in FIG. 6, the repeater 602 includes induction coils 604 and 606 to inductively couple to the DUC 104 and power charger 102, respectively, for the purpose of communicating both power and data (over the forward channel 114 and back channel 116).

By leveraging channels (114 and 116) provided by wireless charging interfaces (106, 108) used for wireless charging, bi-directional communications can be performed between the power charger 102 and the DUC 104 while the DUC 104 is being wirelessly charged by the power charger 102. Effectively, the same physical interface is used for both wireless charging and bi-directional communications.

A trigger for bi-directional communication can be based on an exchange of information indicating which of the power charger 102 and DUC 104 wants to establish the bi-directional communication. Assuming that NFC communication is used, once a bi-directional communication (e.g. peer-to-peer communication) is established, the NFC infrastructure (e.g. NFC services module 322 in FIG. 3) of the DUC 104 can be employed, which can simplify the design of the power charger 102 and DUC 104.

In scenarios where the DUC 104 is placed in the proximity of the power charger 102 for an extended duration (for charging the DUC 104), the relatively slow speed of the back channel 116 in some examples may not present an issue.

Machine-readable instructions of modules described above (including those in the power charger 102 and DUC 104) are loaded for execution on a processor. Data and instructions are stored in respective storage devices, which are implemented as one or multiple computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A method comprising:
wirelessly charging a first device by a second device; and
performing bi-directional communication between the first device and the second device during the wireless charging, wherein the bi-directional communication includes messaging from the second device to the first device, the messaging including information other than information relating to wireless charging.

2. The method of claim 1, wherein wirelessly charging the first device by the second device comprises wirelessly charging the first device by a wireless power charger.

3. The method of claim 1, wherein the bi-directional communication comprises communication over wireless channels established using a physical interface for performing wireless charging.

4. The method of claim 1, wherein the messaging includes messaging containing information selected from among a Near Field Communication message, an identification associated with the second device, status information relating to a status at the second device, control information relating to control of a feature of the first device, financial information, information for establishing a communications connection between the first and second devices, information useable by the first device to communicate with another endpoint, coupon information, and information relating to a type of the second device.

5. The method of claim 1, further comprising:
producing the messaging using an accessory at the second device.

6. The method of claim 5, wherein the accessory is selected from among a storage device and a controller.

7. The method of claim 1, further comprising receiving content of the messaging at a first services module of the first device.

8. The method of claim 7, further comprising:
routing, by a switch in the first device, the content of the messaging to the first services module for handling.

9. The method of claim 8, further comprising:
receiving second messaging from the second device, the second messaging containing content of a type different from a type of the content of the first messaging;
routing, by the switch, the content of the second messaging to a second services module for handling.

10. The method of claim 1, wherein the bi-directional communication further includes messaging relating to the wireless charging.

11. A wireless charger comprising:
a wireless charging interface to wirelessly power an electronic device and receive information transmitted by the electronic device; and
a messaging accessory to produce messaging for transmission to the electronic device through the wireless charging interface, while the wireless charging interface is providing wireless power to the electronic device, wherein the messaging including information other than information relating to wirelessly powering the electronic device.

12. The wireless charger of claim 11, wherein the wireless charging interface is to provide a wireless channel from the wireless charger to the electronic device, the messaging for transmission over the wireless channel.

13. The wireless charger of claim 11, wherein the messaging includes near-field communication (NFC) messaging.

14. The wireless charger of claim 11, wherein the messaging includes information useable to identify features of the wireless charger.

15. The wireless charger of claim 14, wherein the information useable to identify features of the wireless charger includes Universal Serial Bus (USB) identifier information.

16. The wireless charger of claim 11, wherein the wireless charging interface is to receive information from the electronic device useable to identify features of the electronic device.

17. The wireless charger of claim 11, wherein the messaging includes messaging for establishing a Bluetooth or Wi-Fi connection between the wireless charger and the electronic device.

18. The wireless charger of claim 11, wherein the messaging includes information useable by the electronic device to establish a communication session with an external entity coupled to the wireless charger over a network.

19. The wireless charger of claim 11, wherein the messaging includes financial information.

20. An electronic device comprising:
a wireless charging interface to wirelessly receive power from a wireless charger and to send information to the wireless charger over a forward channel between the electronic device and the wireless charger; and
a processor to receive content of messaging transmitted by the wireless charger over a back channel between the electronic device and the wireless charger, wherein the messaging is received over the back channel while the electronic device is being wirelessly powered from the wireless charger, and the messaging including information other than information relating to wirelessly powering the electronic device by the wireless charger.

21. The electronic device of claim 20, further comprising a wireless charging driver to receive a message from the wireless charging interface, the message received over the back channel, and the wireless charging driver including a switch to selectively route the message to one of a plurality of services modules based on a type of the message.

22. The electronic device of claim 21, wherein the plurality of services modules includes a first services module to process near-field communication (NFC) messaging, and a second services module to process messaging other than NFC messaging.
